(19) United States
(12) Patent Application Publication
(10) Pub. No.: US 2016/0177130 A1
(43) Pub. Date: Jun. 23, 2016

(54) HYBRID POLYSILOXANE COATED ARMOR OR FIBER SUBSTRATES

(71) Applicants: Ryan Hale Savage, Salt Lake City, UT (US); Ryan Edward Payne, Pleasant Grove, UT (US); Brad Corbin Mackerell, Cedar Hills, UT (US)

(72) Inventors: Ryan Hale Savage, Salt Lake City, UT (US); Ryan Edward Payne, Pleasant Grove, UT (US); Brad Corbin Mackerell, Cedar Hills, UT (US)

(21) Appl. No.: 14/595,820

(22) Filed: Jan. 13, 2015

Related U.S. Application Data
(60) Provisional application No. 61/926,843, filed on Jan. 13, 2014.

(51) Int. Cl. C09D 183/06

(52) U.S. Cl. CPC C09D 183/06

(57) ABSTRACT

The disclosure herein relates to articles and related methods that utilize hybrid polysiloxane coatings to increase the strength of an armored substrate. In one embodiment, a hybrid polysiloxane coated armor substrate can comprise i) a hybrid polysiloxane coating which includes a polysiloxane epoxy polymer having 20% to 90% siloxane content by weight; and ii) an armor substrate coated with the hybrid polysiloxane coating. The hybrid polysiloxane includes chemical components, e.g., the polysiloxane epoxy polymer, that are covalently bonded to the armor substrate.

The present application claims the benefit of U.S. Provisional Patent Application No. 61/926,843, filed Jan. 13, 2014, the entirety of which is incorporated herein by reference.

### BACKGROUND

Many designs for armored articles, e.g., body armor, have been proposed and commercialized. Such designs can be used for resisting ballistic, explosive, and puncture threats. Standards have been proposed and adopted throughout the world to ensure minimum capabilities of body armor for resisting ballistic objects. See, for example, NIJ Standard—0101.04 “Ballistic Resistance of Personal Body Armor”, issued in September 2000. This report defines capabilities for body armor for level IIA, II, IIIA and III protection. To achieve level II protection, the armor must have no penetration and no more than a backface deformation of 44 mm by a projectile such as a 0.357 magnum projectile at a velocity (Vo) defined as 1430 ft/sec plus or minus (+/−) 30 feet per sec (436 m/sec+/−9 m/sec). To achieve level IIIA protection, the armor must have no penetration and no more than a backface deformation of 44 mm by a projectile such as a 0.44 magnum projectile at a velocity (Vo) defined as 1430 ft/sec plus or minus (+/−) 30 feet per sec (436 m/sec+/−9 m/sec). Body armor is frequently designed with a margin of safety surpassing the requirements of this standard. However, increasing the margin of safety typically increases the cost and weight and decreases the flexibility of the body armor.

On the other hand, designs for body armor for resisting puncture threats can include resistance to spike (e.g., ice pick) or knife stabbing or slashing threats. However, such designs typically are not optimum or even necessarily able to protect against ballistic threats. Separate standards have been published providing different tests and requirements for such spike or knife resistant body armor compared to standards for ballistic resistant body armor. Thus, those skilled in the art do not assume that spike or knife resistant body armor is always particularly useful in designing ballistic resistant body armor.

Body armor meeting the NIJ ballistic standard level II or IIIA protection is made from woven fabric layers from high tenacity multifilament yarns, such as para-aramid yarns. Such woven fabric layers provide very good penetration resistance against bullets and fragments. However, woven fabric layers alone provide less protection against backface deformation requiring more layers and increased weight to meet the margin of safety or even the standard. Hybrid body armor meeting the level II or IIIA protection can be made using a plurality of such woven fabric layers stacked in combination with a plurality of unidirectional assemblies. The assemblies can comprise a unidirectional tape made of an array of parallel high tenacity multifilament yarns in a matrix resin stacked with adjacent tapes with their yarns at angles inclined with respect to adjacent tapes. Typically, the yarns in the tapes are at right angles with respect to yarns in adjacent tapes. These hybrid body armors provide good penetration resistance against bullets, greater protection against backface deformation, but replacing woven fabric layers with unidirectional assemblies can reduce protection against fragments, increase rigidity, and increase cost. That being stated, it is noted that body armor meeting the level II or IIIA protection can be made solely using a plurality of the unidirectional assemblies. They provide good penetration resistance against bullets, very good protection against backface deformation, but they typically provide the least protection against fragments, are more rigid than the other options, and are often the most expensive.

As such, research and development for armored substrates and woven fiber substrates that provide cost effective increased protection continue to be sought.

### DETAILED DESCRIPTION

The present disclosure relates to articles and methods using a hybrid polysiloxane coating to increase the strength of an armored substrate or woven fibers. In one embodiment, a hybrid polysiloxane coated armor substrate can comprise i) a hybrid polysiloxane coating which includes a polysiloxane epoxy polymer having a siloxane content of 20% to 90% by weight; and ii) an armor substrate coated with the hybrid polysiloxane coating. The hybrid polysiloxane includes a chemical component, e.g., the polysiloxane epoxy polymer, that can be covalently bonded to the armor substrate, typically at the surface, though this is not required. In one aspect, the hybrid polysiloxane coating can increase the tensile strength of the armor substrate by at least 50% (as compared to an uncoated armor substrate). Pure polysiloxanes coated on the armor fibers described herein tend to be too brittle to provide the flexibility and other properties that can be desirable for fibrous armor coatings. By using a hybrid copolymer of a siloxane and epoxy, tensile strength, flexibility, elongation at break, and/or modulus, etc., properties can be improved to provide desirable improvements in ballistic and puncture resistances.

In another embodiment, a method of increasing the tensile strength of an armor substrate can comprise coating the armor substrate with a hybrid polysiloxane coating comprising a polysiloxane epoxy polymer having a siloxane content of 20% to 90% by weight to provide a hybrid polysiloxane coated armor substrate. In one aspect, the siloxane content can be 30% to 80% by weight. Additionally, in one embodiment, the polysiloxane epoxy polymer can be cured with an amino alkoxysilyl functional silane. Generally, the hybrid polysiloxane includes a chemical component, e.g., the polysiloxane epoxy polymer, that is covalently bonded to the armor substrate, typically at the surface, though this is not required. In one specific example, the hybrid polysiloxane coating can increase the tensile strength of the armor substrate by at least 50% compared to an uncoated armor substrate.

In another embodiment, a method of enhancing armor protection to a subject or group of subjects can comprise obtaining an armor substrate including a hybrid polysiloxane coating chemically bonded thereto, wherein the hybrid polysiloxane includes a polysiloxane epoxy polymer. The method can further include positioning the armor substrate coated with the hybrid polysiloxane coating in between the subject or group of subject and a potential ballistic, explosive, or puncture threat.

In addition to the coated armor substrates discussed herein, the present disclosure provides for coated fibers or fiber substrates that may not be intended for ballistic resistance. These coatings can also be beneficial for strengthening the fiber substrate as a whole, as well as provide other benefits. In one embodiment, a hybrid polysiloxane coated fiber can comprise a fiber substrate coated with an epoxy polysiloxane hybrid coating having a 20% to 90% siloxane content by weight. In one example, the polysiloxane epoxy polymer can be covalently bonded to the fiber substrate.

In each of the examples, the coated substrates and fibers can have particularly exceptional properties. In one embodiment, the coated fiber or coated substrate can have a corrosion resistance of 0.1 to 3 as measured by ISO 7253 (1996). In another embodiment, the coated fiber or coated substrate can have an ultimate tensile strength of 15 MPa to 30 MPa, an elongation at break of greater than 1%, greater than 3%, or greater than 5%, and/or a modulus of greater than 0.5 MPa, or from 0.5 MPa to 3 MPa. Elastomeric adhesion can be greater than about 1500 psi, greater than 2000 psi, or greater than 2500 psi.

Additional features and advantages of the invention will be apparent from the detailed description that follows, which illustrates, by way of example, features of the invention.

An armored substrates used in a number of technologies can be coated with a hybrid polysiloxane coating comprising a polysiloxane epoxy polymer that increases the strength of the armored substrate. In one aspect, the coated armored substrate can have an increase in tensile strength of at least 50% compared to an uncoated armor substrate. For comparison purposes, when referring to coated armor substrates and uncoated armor substrates in the present disclosure in a single context, the same substrate is used, except for the coating. In many instances, the armor substrate exemplified is a para-aramid fiber material (Kevlar® by Dupont); however, other fibrous and other armor substrates can also benefit from the coatings of the present disclosure. In other words, even though discussions and examples related improving the tensile strength for ballistic, explosive, and stabbing impacts as it relates to Kevlar® are described herein, it is understood that this discussion is not intended to be limiting to a specific type of armor substrate.

Regarding the improvement in tensile and other strength properties provided by the coatings of the present disclosure, without being bound by any particular theory, it is thought that the present coatings can increase the tensile strength of an armored substrate by covalently bonding with the substrate. As such, in one embodiment, the coating can increase the tensile strength of the hybrid polysiloxane coated armor substrate by at least 50%, or at least 100% compared to an uncoated armor substrate. In other aspects, the tensile strength can be increased by at least 200%, 300%, 400%, and in one specific aspect, by 500%.

As mentioned, the hybrid polysiloxane coatings disclosed herein generally comprise a polysiloxane epoxy polymer. Examples of products that can be used or modified include PSX 700 Engineered Siloxane Coating from PPG Industries PTY. LTD., or Precision PC5 Siloxane from Precision Coatings. Modifications of these coatings can be carried out to enhance durability, if the application would benefit from enhanced durability, as would be appreciated by one skilled in the art after considering the present disclosure. Regarding the polysiloxane epoxy per se, any suitable molecular weight can be used, provided the coating remains at least relatively flexible and can remain adhered to the surface of the fiber substrate. In one specific example, the polymer can generally have a weight average molecular weight (Mw) from 400 to 1,000,000. In some aspects, the Mw can be from 400 to 500,000; 400 to 100,000; or 400 to 50,000; and in one specific aspect, from 400 to 15,000.

In order to prepare the coating material, typically, a solvent is used as a carrier. Thus, the present coatings generally comprise a solvent that solvates the polymer and other optional additives. Alternatively, the solvent carrier can finely disperse the polymer and/or additives in order to carry the polymer and/or additives to the substrate. In certain examples, the solvent is typically an organic solvent. In one embodiment, the solvent can be 1-chloro-4-(trifluoromethyl) benzene (CAS #98-56-6) also known as PCBTF. Other suitable solvents can include 16060 VOC Exempt Reducer II available from Precisions Coatings Inc. In another example, the epoxy modified polysiloxane can be prepared with no added solvent, or only a very low amount of solvent, e.g., less than 20%, less than 15% by weight, or less than 10% by weight. Thus, if desired or needed, solvent can be used to provide a coating composition that is suitable for coating on the armor or other fibers described herein.

It is believed that epoxy modified polysiloxane would can provide twice (2×), or even 3× to 4× the durability when exposed to the elements compared to other polymers often used for coatings, e.g., polyurethanes. Furthermore, these materials are have better flexibility, elongation to break, modulus, etc., than polysiloxanes that are not organically modified as described herein. The mechanical properties of these materials over long periods of time are also quite acceptable. One reason for this may be that the silicon in the polysiloxane polymer backbone is already partially oxidized, e.g., approximately 50% to 75% oxidized with each Si atom typically bonded to 2 to 3 oxygen atoms. As a result, resistance of the polysiloxanes to attack by atmospheric oxygen and oxidizing chemicals is improved compared to an unoxidized C—C bond. Thus, a complex hybrid copolymer network that has the desirable anti-oxidative properties provided by the siloxane backbone combined with the enhanced flexibility, etc., contributed by the epoxide groups provides an acceptable combination properties suitable for the coated fibrous structures of the present disclosure.

In further detail regarding the complexity of these copolymer networks, in one example, it is noted that there are multi cross-linking reactions that can occur in preparing these coatings. For example, the epoxy modified polysiloxanes may be cured with an amino alkoxysilyl functional silane. Hydrolytic polycondensation reactions (catalyzed by water) can occur between the alkoxysilyl groups of the curing agent and the polysiloxane, with potential for other reactions to take place as well. Though these polymers have a siloxane backbone, they can have crosslinking that is similar in density as a typical epoxy. Temperature and relative humidity on both the organic (epoxy) and inorganic (siloxane) groups can also impact the hybrid network that is being formed. Thus, any of these and other parameters can be adjusted to generate an acceptable polymer that provides the properties being sought. For example, in one embodiment, the hybrid polysiloxane can be organically modified, e.g., epoxide with or without other organic modification, at from 10% to 80% by weight, from 20% to 70% by weight, from about 15% to 35% by weight, or in one specific example, from 20% to 30% by weight. It is noted that thought the hybrid polysiloxanes of the present disclosure are described as polysiloxane epoxy polymers, the organic modification described herein is not limited to epoxide groups only. Other organic groups can also be present along with the epoxide groups, including substituted or unsubstituted alkyl or aryl moieties to name a few. Thus, the weight percentages of organic modification above constitute all organic modification, including the epoxy modification.

Organic modification can provide or assist the polysiloxane, which may otherwise be brittle, etc., with its adhesion, durability, flexibility, etc., as well as to assist with the coating providing improved ballistic or puncture resistance. Stated another way, too low a level of organic (epoxide groups and optionally other organic groups) modification may result in films which have too high a polysiloxane characteristic, e.g., glass-like, brittle, low adhesion, lower flexibility, low impact resistance, etc. Too high of levels of organic modification may detract from polysiloxane characteristics such as resistance to ultraviolet light and oxidation. By including the epoxide groups (with or without other organics) in the polymer at the appropriate proportions, improvement to one or more of these characteristics can be achieved.

In some examples, the hybrid polysiloxane coating can comprise an epoxy-polysiloxane polymer, such as described in U.S. Pat. No. 5,804,616, which is incorporated herein by reference. The epoxy-polysiloxane polymer can include a blend of an epoxy resin with a polysiloxane. The polymer can include from 10 to 60 weight percent epoxy resin. In a particular example, the polymer can include from 20 to 40 weight percent epoxy resin. Non-limiting examples of the epoxy resin can include non-aromatic hydrogenated cyclohexane dimethanol and diglycidyl ethers of hydrogenated Bisphenol A-type epoxide resins, such as Epon® DPL-862, Eponex® 1510, Heloxy® 107 and Eponex® 1513 (hydrogenated bisphenol A-epichlorohydrin epoxy resin) from Shell Chemical in Houston, Texas; Santolink® LSE-120 from Monsanto located in Springfield, Mass.; Epodil 757 (cyclohexane dimethanol diglycidylether) from Pacific Anchor located in Allentown, Pa.; Araldite® XUGY358 and PY327 from Ciba Geigy located in Hawthorne, N.Y.; Epirez® 505 from Rhone-Poulenc located in Lousiville, Ky.; Aroflint® 393 and 607 from Reichold Chemicals located in Pensacola, Fla.; and ERL4221 from Union Carbide located in Tarrytown, N.Y. Other suitable non-aromatic epoxy resins include DER 732 and DER 736; Heloxy® 67, 68, 107, 48, 84, 505 and 71 each from Shell Chemical; PolyBD-605 from Arco Chemical of Newtown Square, Pa.; Erisys® GE-60 from CVC Specialty Chemicals, Cherry Hill, N.J.; and Fineclad® A241 from Reichold Chemical.

The polysiloxane can in some examples have a structure according to formula

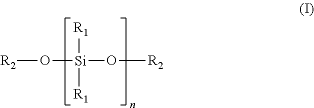

where R₁ and R₂ are each either a hydrogen atom, a hydroxyl group, or an organic group. In some cases R₁ can be a hydroxyl group, an alkyl group, an aryl group, or an alkoxy group having up to six carbon atoms. R₂ can be a hydrogen atom, an alkyl group, or an aryl group having up to six carbon atoms. The number “n” can be selected so that the weight average molecular weight of the polysiloxane is from about 400 Mw to about 50,000 Mw, or about 1,000 Mw to 10,000 Mw. Specific non-limiting examples of polysiloxanes include DC-3074, DC-3037, DC840, Z6018, Q1-2530 and 6-2230 from Dow Corning; and GE SR191, SY-550, and SY-231 from Wacker

The epoxy-polysiloxane polymer can also include a hardener. The hardener can generally be an aminosilane. Non-limiting examples of aminosilane hardeners include aminoethyl aminopropyl triethoxysilane, n-phenylaminopropyl trimethoxysilane, trimethoxysilylpropyl diethylene triamine, 3-(3-aminophenoxy)propyl trimethoxy silane, amino ethyl amino methyl phenyl trimethoxy silane, 2 amino ethyl 3 aminopropyl, tris 2 ethyl hexoxysilane, n-aminohexyl aminopropyl trimethoxysilane and trisaminopropyl trismethoxy ethoxy silane

During curing, the epoxy resin can react with the amine moiety of the aminosilane hardener to form epoxy polymer chains. At the same time, the silane moiety of the aminosilane hardener can undergo a hydrolytic polycondensation reaction with the polysiloxane. Thus, a cross-linked network of epoxy polymer and polysiloxane is formed.

In further detail, particularly with respect to ballistic and puncture/stab applications, the coatings can be formulated with acceptable flexibility, strength, etc. for a specific desired use. For example, oxysilane and silicone resin precursors can be selected for molecular weight, degree of crosslinking, reactivity type and amount, as well as for their film properties, cure speed, and compatibility with the epoxide-group containing polymers that are to be hybridized with the polysiloxane web. Consistent with the organic portions described, the polysiloxane/epoxy hybrid coatings will typically include from 20% to 90% by weight of the siloxane content. Other examples include the presence of from 30% to 80% siloxane content by weight, from 65% to 85% siloxane content by weight, or from 70% to 80% siloxane content by weight. Within these ranges, acceptable adhesion, mechanical properties, chemical resistance, corrosion resistance, weathering resistance, flexibility, strength, ballistic resistance, puncture/stab resistance, and/or the like can be achieved.

In further, detail, epoxy siloxane hybrid coatings can be applied, in one example, at high volume solids, e.g., greater than 80% by weight, greater than about 87% by weight, greater than about 90% by weight, e.g., volatile organic solvents (VOC) less than 2.0 lb/gal, less than 1.0 lb/gal, or less than 0.7 lb/gal. Stated another way, epoxy siloxane hybrids can be prepared to have ultra high solids, low VOC, and cure at ambient temperature to provide coatings with an acceptable combination of resistance to weathering and corrosion, as well as to provide the enhanced ballistic and puncture/stab resistance described herein.

Regarding the coating composition per se, in addition to the polysiloxane epoxy polymer, other ingredients can also be used to provide other benefits to the coatings described herein. For example, the present coatings can include additives such as ultraviolet absorbers (UVA) and/or Hindered Amine Light Stabilizer (HALS). These materials can help improve not only the stability of the coatings described herein, but can also provide protection to the underlying substrate as well. The present coatings can also protects against blood, water, sweat and frictional wear between substrate layers, all of which have been shown to reduce armored substrate, e.g. Kevlar, longevity. In one embodiment, the UVAs can include benzotriazoles, benzoates, benzophenones, salicylates, cyanoacrylate rate-based absorbers, nickel complex salt-based absorbers, triazine-based absorbers, hindered amine-based ultraviolet absorbers, and/or cinnamic acid ester type UV absorption agents.

Examples of benzotriazole ultraviolet absorbers include 2-(2′-hydroxy-5′-methylphenyl)-5-carboxylic acid butyl ester benzotriazole, 2-(2′-hydroxy-5′-aminophenyl) benzotriazole, 2-(2′-hydroxy-3′,5′-dichlorophenyl) benzotriazole, 2-(2′-hydroxy-5′-cyclohexylphenyl) benzotriazole, 2-(2′-hydroxy-5′-methoxyphenyl) benzotriazole, 2-(2′-hydroxy-3′,5′-di-tert-butylphenyl)-5-chloro-benzotriazole, 2-(2′-hydroxy-3′,5′-dimethyl-phenyl) benzotriazole, 2-(2′-hydroxy-3′-tert-butyl-5′-methylphenyl)-5-chloro-benzotriazole, 2-(2′-hydroxy-3′,5′-di-tert-butylphenyl)-5′-chloro-benzotriazole, 2-(2′-hydroxy-4′,5′-dimethylphenyl)-5-carboxylic acid benzotriazole butyl ester, 2-(2′-hydroxy-5′-methylphenyl)-5,6-di-chlor-benzotriazole, 2-(2′-hydroxy-3′,5′-dimethylphenyl)-5-ethyl sulfone benzotriazole, 2-(2-hydroxy-4-octyloxyphenyl)-2H-benzotriazole, 2-(2′-hydroxy-5′-methylphenyl) benzotriazole, 2-(2′-hydroxy-5′-methylphenyl)-5-ethyl sulfone benzotriazole, 2-(2′-hydroxy-3′,5′-dimethylphenyl)-5-methoxy-benzotriazole, 2-(2′-methyl-4′-hydroxyphenyl) benzotriazole, 2-(2′-stearyloxy-3′,5′-dimethylphenyl)-5-methyl-benzotriazole, 2-(2′-hydroxy-3′-methyl-5′-tert-butylphenyl) benzotriazole, 2-(2′-hydroxy-5′-methoxyphenyl)-5-methyl benzotriazole, 2-(2′-hydroxy-5′-tert-butylphenyl)-5-chloro-benzotriazole, 2-(2′-hydroxy-5-carboxylic acid phenyl) benzotriazole ethyl ester, 2-(2′-hydroxyphenyl) benzotriazole, 2-(2′-hydroxy-4′,5′-dichlorophenyl) benzotriazole, and/or 2-(2′-hydroxy-5′-methylphenyl)benzotriazole, and (2′-acetoxy-5′-methylphenyl) benzotriazole.

Examples of benzophenone ultraviolet absorbers include 2-hydroxy-4-n-octoxybenzophenone; 2,2′-dihydroxy-4-methoxybenzophenone; 2,2′-dihydroxy-4, 4′-dimethoxybenzophenone; bis-(2-methoxy-4-hydroxy-5-benzoyl phenyl)methane; 2-hydroxy-4-methoxy benzophenone; 2,4-dihydroxybenzophenone; 2-hydroxy-4-methoxy-2′-carboxybenzophenone; 2-hydroxy-5-chlorobenzophenone; 2-hydroxy-4-benzoyloxy benzophenone; and/or 2-hydroxy-4-methoxy-5-sulfone.

Examples of salicylate ultraviolet absorbers include phenyl salicylate, p-tert-butylphenyl salicylate; p-octyl phenyl salicylate; resorcinol monobenzoate; and/or 2,4-di-tert-butyl-phenyl.

Examples of cyanoacrylate ultraviolet absorbers include methyl-2-cyano-3-methyl-3-(p-methoxyphenyl)acrylate; butyl-2-cyano-3-methyl-3-(p-methoxyphenyl) acrylate; and/or ethyl-2-cyano-3, 3′-diphenyl acrylate.

Examples of the nickel complex salt-based ultraviolet absorbers include 2,2′-thiobis(4-tert-octylphenolate) triethanolamine nickel (II); nickel bis(octylphenyl) sulfide, 2,2′-thiobis(4 -tert-octylphenolate)-n-butylamine nickel (II); and/or 2,2′-thiobis(4-tert-octylphenolate)-2-ethylhexylamine nickel (II).

Hindered amine light stabilizer as (HALS), can include compounds having the following general structure (II):

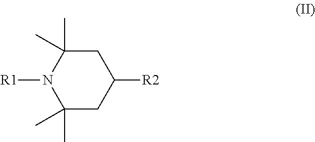

where R1 is CH₃ or H, and R2 is OH or OR3, where R3 is a substituted or unsubstituted, branched, linear, or cyclic, alkyl or aryl chain, optionally including functional groups and/or hetero atoms.

Examples of hindered amine light stabilizers include diethyl sebacate; bis(2,2,6,6-tetramethyl-4-piperidyl) sebacate; bis(1,2,2,6,6-pentamethyl-4-piperidyl) sebacate; polycondensate of succinic acid with N-(2-hydroxyethyl)-4-hydroxy-2,2,6,6-tetramethyl piperidine; poly-([6-[(1,1,3,3-tetramethylbutyl)-imino]-1,3,5-triazine-2,4-diyl][2-(2,2,6,6-tetramethyl-4-piperidyl)imino]-hexamethylene-[4-(2,2,6,6-tetramethyl-4-piperidyl)imino]; 1-[2-[3-(3,5-di-t-butyl-4-hydroxy-phenyl)-propionyloxy]ethyl]-4-[3-(3,5-di-t-butyl-4-hydroxyphenyl)-propionyloxy]-2,2,6,6-tetramethyl piperidine; tetrakis (2,2,6,6,-tetramethyl-4-piperidyl)-1,2,3,4-butane tetracarboxylic esters; tetrakis (1,2,2,6,6-pentamethyl-4-piperidyl)-1,2,3,4-butane tetracarboxylic esters; polycondensate of N,N′-bis(2,2,6,6-tetra-methyl-4-piperidyl)hexamethylene diamine with 1,2-dibromoethane; and/or polycondensate of 1,6-bis-(2,2,6,6-tetramethyl-4-piperidylamino)hexane with 2,4-dihalo-6-morpholino-1,3,5-triazine.

In one embodiment, the coating can include UVA: 2-hydroxy-4-n-octoxybenzophenone, as well as HALS: bis (1,2,2,6,6-pentamethyl-4-piperdinyl)-sebacate.

Assuming that the hybrid polysiloxane coating composition formulation is not applied as a pure hybrid polysiloxane epoxy polymer, the coating composition as a whole, in one specific example, can include from 50% to 99% by weight polysiloxane epoxy polymer (or from 80% to 95% by weight), from 1% to 50% by weight of a solvent carrier (or from 5% to 20% by weight), and optionally, from 0.01% to 5% by weight UVA and/or from 0.01% to 5% by weight HALS. Other ingredients such as binders, flow control agents, co-solvents, biocides, activator, reducer, or the like, can also be included in the formulations. Furthermore, it is noted that in some examples, a two part mixture can be used which is typically admixed just prior to spraying, as is the case with the Precision PC5 Siloxane and other similar systems. Thus, the above weight percentages are based on mixed formulations just prior to application. In further detail, as the solvent carrier will largely evaporate leaving behind the polymer and other additives (if present), the weight percentages of the solids will be higher in the coating application after applied and dried.

The coated armor substrates disclosed herein generally comprise a coating sufficient to increase the tensile strength of the armor substrate. In one embodiment, the hybrid polysiloxane coating can comprise multiple layers. In one aspect, the hybrid polysiloxane coating can have a thickness of about 0.01 to 10 mils. In another aspect, the hybrid polysiloxane coating can have a thickness of about 0.1 to 5 mils. In still other examples, the thickness can be from about 0.1 to 3 mils, or from 0.1 to 1 mils. It has been surprisingly discovered that in some examples, a thin coating provides equal or even superior stopping power of certain bullets compared to certain thicker coating thicknesses. Furthermore, because thinner coatings are sometimes more effective, by using such thinner coatings, the added benefit of retaining flexibility of the body armor can be achieved by virtue of these thinner coatings. Furthermore, the flexibility of the coating on the armor substrate can be adjusted chemically by adjusting the ratio of epoxy to siloxane groups, by adjusting the temperature and humidity while processing, by chemically adjusting the crosslinking, etc.

Generally, the armor substrate can be any type of substrate used in armor applications and can be capable of bonding to the present coatings. In one embodiment, the armor substrate can be ceramic, polymer, fabric, aramid fiber, carbon-fiber based material, and combinations thereof. In another embodiment, the armor substrate can include clothing, ceramic plates, mechanical parts, tires, containment structures, storage containers, military equipment, and combinations thereof. Thus, for example, the present coatings can be useful in the manufacture, refurbishment, or modification of various items, such as protective clothing such as motorcycle riding gear, racing gear, extreme sports gear, personal protection clothing; bullet proof vests or suits; puncture proof vests or suits; blast proof vests or suits; helmets; riot gear; armored vehicles or transports; military vehicles; aircraft; aircraft belly pans and seats; aircraft control surfaces; satellites or other aerospace surfaces; tires; brief cases; backpacks; safe rooms; infrastructure and energy asset protection structures such as bridges, tunnels, stadiums, buildings, data centers, gas pipe lines, airports, train stations, power plants, etc.; marine vessels; bomb blast containment structures; containers; and combinations thereof. In other words, though the above list is not believed to be exhaustive, any armor structure that is suitable for covalent attachment to the coatings described herein that would benefit from improved ballistic, explosive, or puncture protection can be prepared in accordance with examples of the present disclosure.

Regarding fiber-type armor, in addition to Kevlar®, the coatings described herein are particularly useful for enhancing armor characteristics of filaments made from any polymer that produces a high-strength fiber, including, for example, polyamides, polyolefins, polyazoles, nylon polymers, and mixtures of these. That being stated, in one embodiment, the fiber can be an aramid fiber. The term “aramid” means a polyamide wherein at least 85% of the amide (—CONH—) linkages are attached directly to two aromatic rings. Suitable aramid fibers are described in Man-Made Fibres—Science and Technology, Volume 2, Section titled Fibre-Forming Aromatic Polyamides, page 297, W. Black et al., Interscience Publishers, 1968, which is incorporated herein by reference in its entirety.

In one embodiment, the aramid fiber can be a para-aramid fiber. In one aspect, the para-aramid fiber can be poly(p-phenylene terephthalamide), which is called PPD-T. Such PPD-T compounds generally include the homopolymer resulting from mole-for-mole polymerization of p-phenylene diamine and terephthaloyl chloride and, also, copolymers resulting from incorporation of small amounts of other diamines with the p-phenylene diamine and of small amounts of other diacid chlorides with the terephthaloyl chloride. As a general guideline, other diamines and other diacid chlorides can be used in amounts up to as much as about 10 mole % of the p-phenylene diamine or the terephthaloyl chloride, or perhaps slightly higher, provided only that the other diamines and diacid chlorides have no reactive groups which interfere with the polymerization reaction. PPD-T, also, includes copolymers resulting from incorporation of other aromatic diamines and other aromatic diacid chlorides such as, for example, 2,6-naphthaloyl chloride or chloro- or dichloroterephthaloyl chloride or 3,4′-diaminodiphenylether. Commercial examples of poly(p-phenylene terephthalamide) include Kevlar® (from DuPont) and Twaron® (from Teijin Aramid).

In one embodiment, the aramid fiber can be a meta-aramid fiber. In one aspect, the meta-aramid fiber can be poly(m-phenylene terephthalamide). One commercial example of poly(m-phenylene terephthalamide) is Nomex® (from DuPont).

In another embodiment, the armored substrates or fiber substrates can comprise a nylon polymer, e.g. nylon 6 or nylon 6,6. Such commercially available nylon polymers include Cordura® Ballistic Fabric, Cordura® Lite Fabric, Cordura® Ultralite Fabric, Cordura® Classic Fabric, Cordura® Ecomade Fabric available from Invista™.

There are also other aramid fibers that can likewise be used, as would be appreciated by one skilled in the art after considering the present disclosure.

Additives can be used with the aramid and it has been found that up to as much as 10% by weight or more of other polymeric material can be blended with the aramid. Copolymers can be used having as much as 10% by weight or more of other diamine substituted for the diamine of the aramid or as much as 10% by weight or more of other diacid chloride substituted for the diacid chloride or the aramid.

When the polymer is polyolefin, in one embodiment, the polyolefin can be polyethylene or polypropylene. The term “polyethylene” generally refers to a predominantly linear polyethylene material of more than one million molecular weight that may contain minor amounts of chain branching or comonomers not exceeding 5 modifying units per 100 main chain carbon atoms, and that may also contain admixed therewith not more than about 50% by weight of one or more polymeric additives such as alkene-1-polymers, in particular low density polyethylene, propylene, and the like, or low molecular weight additives such as anti-oxidants, lubricants, ultra-violet screening agents, colorants and the like which are commonly incorporated. Such polyethylenes can include extended chain polyethylene (ECPE) or ultra high molecular weight polyethylene (UHMWPE). Such UHMWPE can include polyethylenes having between 2 to 6 million atomic mass units. Commerical examples of UHMWPE include Spectra® (from Honeywell) and Dyneema® (from DSM).

In some embodiments, polyazoles can be used. In one aspect, the polyazoles can include polyarenazoles such as polybenzazoles and/or polypyridazoles. Suitable polyazoles include homopolymers and, also, copolymers. Additives can be used with the polyazoles and up to as much as 10% by weight of other polymeric material can be blended with the polyazoles. Also copolymers can be used having as much as 10% by weight or more of other monomer substituted for a monomer of the polyazoles.

In one embodiment, polybenzazoles can include polybenzimidazoles, polybenzothiazoles, and/or polybenzoxazoles and, more specifically, such polymers that can form fibers having yarn tenacities of 30 grams per denier (gpd) or greater. If the polybenzazole is a polybenzothioazole, in one aspect, it can be poly(p-phenylene benzobisthiazole). If the polybenzazole is a polybenzoxazole, in one aspect, it can be poly(p-phenylene benzobisoxazole) and, in another aspect, can be poly(p-phenylene-2,6-benzobisoxazole) called PBO. One commercial example of poly(p-phenylene-2,6-benzobisoxazole) is Zylon® (from Toyobo Corp.).

In one embodiment, polypyridazoles can include polypyridimidazoles, polypyridothiazoles, and/or polypyridoxazoles and, more specifically, such polymers that can form fibers having yarn tenacities of 30 gpd or greater. In some embodiments, the polypyridazole can be a polypyridobisazole. In one aspect, the poly(pyridobisozazole) can be poly(1,4-(2,5-dihydroxy)phenylene-2,6-pyrido[2,3-d:5,6-d]bisimidazole which is called PIPD.

In one embodiment, the armor substrate can be a carbon fiber based material.

The above-list of potential substrates for use with the hybrid polysiloxane coatings of the present disclosure is merely exemplary, and others can likewise be used as previously described.

In applying the hybrid polysiloxane coatings of the present disclosure to various types of armor, any coating or application technique can be used. The coating can be applied to the external surface of the body armor substrate, e.g., para-aramid fibers, and/or to one or more layers of the layers of the body armor that may not be on the outermost surface of the armor substrate. Likewise, the layers can be coated or soaked prior to complete assembly, or the layers can be coated or soaked after the body armor substrate is fully assembled. Thus, the term “coating” includes both surface treatment, as well as soaking the coating composition into one or more layers from a surface of any layer of the body armor. Likewise, the term “coating” includes application to fibers during the manufacturing process of forming various body armor layers. In one specific example, the coating process can include spraying the hybrid polysiloxane coating on to the armor substrate. Such spraying can be pressurized or gravity fed. Additionally, in one aspect, the spraying can be from an aerosol sprayer. Dip coating, brushing, rolling, wiping, etc., are also techniques that can be used to coat the surface of the armor substrate. These coating processes can be either manual or automated, and certain substrates can even be coated using technologies typically used to coat papers and plastics, e.g., Meyer rod coating, curtain coating, knife-blade coating, etc. The coating thickness can be any coating thickness that is functional, but as mentioned, a thickness from about 0.01 to 10 mils, from about 0.01 to 7 mils, from about 0.1 to 5 mils, from about 0.1 to 3 mils, or from about 0.1 to 1 mils, can be appropriate in many instances.

Once the armor substrate is coated, in one aspect, the method can further comprise drying the hybrid polysiloxane coated armor substrate. Generally, the drying can be for a period of time sufficient to allow the solvent to evaporate. In a few aspects, the drying can be for 2 hours, 4 hours, 8 hours, 12 hours, or 24 hours. Longer or shorter time frames can be used, depending on the substrate, manufacturing parameters, room temperature, whether or not forced and/or heated air is used, etc. Upon sufficient drying, the armor can be placed in its environment for use. For example, Kevlar® armor coated with the hybrid polysiloxane coatings described herein might be inserted into a ballistic vest or other pockets on other armored devices. The application of the coating can be distributed such that a substantially uniform coating is achieved. In one aspect, “substantially uniform” can refer to any coating that has a surface roughness of less than 0.1 mil, where the surface roughness is measured as root mean square (RMS) roughness. Of course, the surface roughness of the coating is determined relative to the surface roughness of the underlying armor substrate to which it is applied.

Although the detailed description herein contains many specifics for the purpose of illustration, a person of ordinary skill in the art will appreciate that many variations and alterations to the details are within the scope of the disclosed embodiments.

Accordingly, the embodiments are set forth without any loss of generality to, and without imposing limitations upon any claimed invention. Before the present disclosure is described in greater detail, it is to be understood that this disclosure is not limited to particular embodiments described, as these may vary. It is also to be understood that the terminology used herein is for the purpose of describing particular embodiments only, and is not intended to be limiting, since the scope of the present disclosure will be limited only by the appended claims. Unless defined otherwise, all technical and scientific terms used herein have the same meaning as commonly understood by one of ordinary skill in the art to which this disclosure belongs.

As used in this specification and the appended claims, the singular forms “a,” “an” and “the” include plural referents unless the context clearly dictates otherwise. Thus, for example, reference to “hybrid polysiloxane” includes a plurality of hybrid polysiloxanes.

In this disclosure, “comprises,” “comprising,” “containing” and “having” and the like can have the meaning ascribed to them in U.S. Patent law and can mean “includes,” “including,” and the like, and are generally interpreted to be open ended terms. The term “consisting of” is a closed term, and includes only the components, structures, steps, or the like specifically listed, and that which is in accordance with U.S. Patent law. “Consisting essentially of” or “consists essentially” or the like, when applied to methods and compositions encompassed by the present disclosure refers to compositions like those disclosed herein, but which may contain additional structural groups, composition components or method steps. Such additional structural groups, composition components or method steps, etc., however, do not materially affect the basic and novel characteristic(s) of the compositions or methods, compared to those of the corresponding compositions or methods disclosed herein. In further detail, “consisting essentially of” or “consists essentially” or the like, when applied to methods and compositions encompassed by the present disclosure have the meaning ascribed in U.S. Patent law and the term is open-ended, allowing for the presence of more than that which is recited (e.g., trace contaminants, components not reactive with the polymer or components reacted to form the polymer, and the like) so long as basic or novel characteristics of that which is recited is not changed by the presence of more than that which is recited, but excludes prior art embodiments. When using an open ended term, like “comprising” or “including,” it is understood that direct support should be afforded also to “consisting essentially of” language as well as “consisting of” language as if stated explicitly.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range includes “about ‘x’ to about ‘y’”. To illustrate, a concentration range of “about 0.1% to about 5%” should be interpreted to include not only the explicitly recited concentration of about 0.1% by weight to about 5% by weight, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”.

The term “about” as used herein, when referring to a numerical value or range, allows for a degree of variability in the value or range, for example, within 10%, in one aspect within 5%, or in one specific aspect within 1%, of a stated value or of a stated limit of a range.

Where features or aspects of the disclosure are described in terms of a list or a Markush group, those skilled in the art will recognize that the disclosure is also thereby described in terms of any individual member or subgroup of members of the Markush group. For example, if X is described as selected from the group consisting of bromine, chlorine, and iodine, claims for X being bromine and claims for X being bromine and chlorine are fully described and supported as if listed individually. For example, where features or aspects of the disclosure are described in terms of such lists, those skilled in the art will recognize that the disclosure is also thereby described in terms of any combination of individual members or subgroups of members of list or Markush group. Thus, if X is described as selected from the group consisting of bromine, chlorine, and iodine, and Y is described as selected from the group consisting of methyl, ethyl, and propyl, claims for X being bromine and Y being methyl are fully described and supported.

As used herein, all percent compositions are given as weight-percentages, unless otherwise stated. When solutions of components are referred to, percentages refer to weight-percentages of the composition including solvent (e.g., water) unless otherwise indicated.

As used herein, all molecular weights (Mw) of polymers are weight-average molecular weights, unless otherwise specified.

As will be apparent to those of skill in the art upon reading this disclosure, each of the individual embodiments described and illustrated herein has discrete components and features that may be readily separated from or combined with the features of any of the other several embodiments without departing from the scope or spirit of the present disclosure. Any recited method can be carried out in the order of events recited or in any other order that is logically possible.

It is noted in the present disclosure that when describing the coated armor substrates or methods, individual or separate descriptions are considered applicable to one another, whether or not explicitly discussed in the context of a particular example or embodiment. For example, in discussing a particular armor substrate per se, the method embodiments are also inherently included in such discussions, and vice versa.

### EXAMPLES

The following examples illustrate properties of the present disclosure. However, it is to be understood that the following are only exemplary or illustrative of the application of the principles of the present devices and methods. Numerous modifications and alternative devices and methods may be devised by those skilled in the art without departing from the spirit and scope of the present compositions and methods. The appended claims are intended to cover such modifications and arrangements. Thus, while the present examples have been described above with particularity, the following provides further detail in connection with what are presently deemed to be the acceptable embodiments.

### Example 1

### Coated Armor Substrate

A Kevlar® 29 Style 745 Ballistic Fabric was obtained from DuPont having the following dimensions: weight: 14 oz. per sq. yd.; width: 50 inch; denier: 3000, weave: plain; thickness: 24.1 (mils) 0.61 (mm); breaking strength: length and width directions with length at1600 (lbf/in) and width at1800 (lbf/in); and thread count: 17 length×17 width. The fabric was coated on one side by spraying a hybrid polysiloxane coating comprising a polysiloxane epoxy polymer solvated in 1-chloro-4-(trifluoromethyl)benzene (Enhanced Xylexin coating available from Precision Coatings, 1940 E. Trafficway, Springfield, Mo. 65802) providing a thickness of 4 mils. The coated fabric was allowed to dry for 24 hours.

### Example 2

### Testing of Coated Armor Substrate

The coated armor substrate of Example 1 was tested for ballistic and puncture resistance. The substrates were placed on a hard surface for support and shot with a Heckler & Koch MP5A3. Thirty rounds of 9 mm 115 grain Full Metal Jacket (FMJ) Round Nose (RN) (1,315 Velocity ft./sec.) were fired at a distance of about 25 feet. None of the projectiles advanced past four layers. Over 90% of the projectiles did not pass the first layer. Additionally, a knife point test was conducted by applying the point of a fixed blade knife with 150 lbs of pressure. The knife did not puncture past the second layer.

### Example 3

### Testing of Coated Armor Substrate

The coated armor substrate of Example 1 was tested for ballistic and puncture resistance. These substrates were placed on a hard surface for support shot with a Beretta M9. Five rounds of 9 mm 115 grain Full Metal Jacket (FMJ) Round Nose (RN) (1,200 Velocity ft./sec.) were fired at a distance of 25 feet. None of the projectiles advanced past four layers. 90%+ of the projectiles did not pass the first layer. Additionally, a knife point test was conducted by applying the point of a fixed blade knife with 150 lbs of pressure. The knife did not puncture past the second layer.

### Example 4

### Testing of Uncoated Armor Substrate

The armor substrate of Example 1 was tested for ballistic and puncture resistance without the coating described herein. Ten uncoated armor substrates (Kevlar® 29 Style 745 Ballistic Fabric) were positioned on a hard surface shot with a Beretta M9. Thirty rounds of 9 mm 115 grain Full Metal Jacket (FMJ) Round Nose (RN) (1,315 Velocity ft./sec.) were fired at a distance of 25 feet. 100% of the projectiles advanced past all ten layers. Additionally, a knife point test was conducted by applying the point of a fixed knife with 150 lbs of pressure. The knife punctured all ten layers. Notably, Kevlar® 29 is a ballistic Kevlar® 29 not designed to be puncture resistant.

### Example 5

### Testing of Uncoated Armor Substrate

The armor substrate of Example 1 was tested for ballistic and puncture resistance without the coating. The substrates were placed on a hard surface for support and shot with a Heckler & Koch MP5A3. Thirty rounds of 9 mm 115 grain Full Metal Jacket (FMJ) Round Nose (RN) (1,315 Velocity ft./sec.) were fired at a distance of about 25 feet. All of the projectiles advanced past all ten layers. Additionally, a knife point test was conducted by applying the point of a fixed blade knife with 150 lbs of pressure. The knife punctured all ten layers.

### Example 6

### Coating Performance

The armor substrate of Example 1 was coated at varying thicknesses and tested as described in Table 1.

TABLE 1

| | |
|---|---|
| Dry Film Thickness of Coating | Number of Layers (out of 10) |
| (mils) | Penetrated |

| | | |
|---|---|---|
| 0 | 10 | (all layers) |
| 1.4 | 4 | (maximum) |
| 4.5 | 3 | (maximum) |
| 9 | 6 | (maximum) |

### Example 7

### Additional Observations Based on Examples 2-6

Current Kevlar®-based soft armor on the market today is constrained by the very limited number of hits the armor can defeat. Under normal operating conditions, Kevlar® cannot defend against a secondary bullet strike (hit) within 4 sq. cm. of the last point of impact. The presently treated Kevlar® unexpectedly took multiple hits (as many as 30 hits) within 1 sq. cm. without failure.

Additionally, current Kevlar® armor applications are vulnerable to sharp object puncture attacks. The presently treated Kevlar effectively defended against sharp object/puncture attacks.

As such, the present coated armor substrate allows superior performance at a fraction of the weight of other known armor substrate, such as ceramic plates, while remaining flexible through a variety of temperatures and conditions. Weight savings over armor substrates with similar stopping power may be estimated at approximately 80%.

Further, while the effectiveness and durability of Kevlar® can be negatively impacted by water, blood, friction, the present coated articles can provide improved resistance to these elements, thus prolonging the overall life and effectiveness of the presently coated armor.

The present process for treating armored substrates, e.g. Kevlar® is simple, fast, and relatively straightforward, and can be provided on a consistent and repeated basis. As such the present treatment process enables products to be made for a variety of soft-armor application including personal body armor, vehicles, and aircraft and is highly cost effective.

What is claimed is:

1. A hybrid polysiloxane coated armor or fiber substrate, comprising:
a hybrid polysiloxane coating comprising a polysiloxane epoxy polymer; and
an armor substrate coated with the hybrid polysiloxane coating, wherein the polysiloxane epoxy polymer is covalently bonded to the armor substrate.

2. The hybrid polysiloxane coated armor or fiber substrate of claim 1, wherein the polysiloxane epoxy polymer has a 20% to 90% siloxane content by weight.

3. The hybrid polysiloxane coated armor or fiber substrate of claim 1, wherein the polysiloxane epoxy polymer has a 10% to 60% epoxy content by weight.

4. The hybrid polysiloxane coated armor or fiber substrate of claim 1, wherein the polysiloxane epoxy polymer is formed from a polysiloxane having a weight-average molecular weight of 400 Mw to 50,000.

5. The hybrid polysiloxane coated armor or fiber substrate of claim 1, wherein the armor or fiber substrate is coated on a surface of at least one outermost layer of the armor or fiber substrate.

6. The hybrid polysiloxane coated armor or fiber substrate of claim 1, wherein the armor or fiber substrate is coated on a surface of at least one inner layer of the armor or fiber substrate.

7. The hybrid polysiloxane coated armor or fiber substrate of claim 1, wherein the armor or fiber substrate is coated such that the hybrid polysiloxane coating penetrates beneath the surface of the armor or fiber substrate to which it is coated.

8. The hybrid polysiloxane coated armor or fiber substrate of claim 1, wherein the polysiloxane epoxy polymer is cured with an amino alkoxysilyl functional silane.

9. The hybrid polysiloxane coated armor or fiber substrate of claim 1, wherein the hybrid polysiloxane coating comprises multiple layers.

10. The hybrid polysiloxane coated armor or fiber substrate of claim 1, wherein the hybrid polysiloxane coating has a thickness of about 0.01 to 10 mils.

11. The hybrid polysiloxane coated armor or fiber substrate of claim 1, wherein the armor or fiber substrate comprises materials selected from the group consisting of ceramics, polymers, fabrics, carbon-fiber based materials, and combinations thereof.

12. The hybrid polysiloxane coated armor or fiber substrate of claim 1, wherein the armor or fiber substrate comprises aramid fibers.

13. The hybrid polysiloxane coated armor or fiber substrate of claim 1, wherein the armor or fiber substrate is integrated with or in use as protective clothing; bullet proof vests or suits; puncture proof vests or suits; blast proof vests or suits; helmets; riot gear; armored vehicles and transports; military vehicles; aircraft; aircraft belly pans and seats; satellites and aerospace surfaces; tires; brief cases; backpacks; safe rooms; infrastructure and energy asset protection structures; marine vessels; bomb blast containment structures; containers; or combinations thereof.

14. The hybrid polysiloxane coated armor or fiber substrate of claim 1, wherein the armor or fiber substrate comprises para-aramid polymers, nylon polymers, polyethylenes, polypyridazoles, polyarenazoles, polybenzazoles, polypyridazoles, polybenzimidazoles, polybenzothiazoles, polybenzoxazoles, polypyridimidazoles, polypyridothiazoles, polypyridoxazoles, derivatives thereof, or combinations thereof.

15. The hybrid polysiloxane coated armor or fiber substrate of claim 1, wherein the hybrid polysiloxane coating increases the tensile strength of the hybrid polysiloxane coated armor or fiber substrate by at least 50% compared to an uncoated armor or fiber substrate.

16. The hybrid polysiloxane coated armor or fiber substrate of claim 1, wherein the hybrid polysiloxane coating further comprises a UV absorber, a hindered amine light stabilizer, or combinations thereof.

17. A method of increasing the tensile strength of an armor or fiber substrate, comprising coating the armor or fiber substrate with a hybrid polysiloxane coating comprising a polysiloxane epoxy polymer to provide a hybrid polysiloxane coated armor or fiber substrate, wherein the polysiloxane epoxy polymer covalently bonds to the armor or fiber substrate.

18. The method of claim 17, wherein the step of coating includes applying the hybrid polysiloxane coating on at least one outermost layer of the armor or fiber substrate.

19. The method of claim 17, wherein the step of coating includes applying the hybrid polysiloxane coating on at least one inner layer of the armor or fiber substrate.

20. A method of providing enhanced armor protection to a subject or group of subjects, comprising:
obtaining an armor or fiber substrate including a hybrid polysiloxane coating chemically bonded thereto, said hybrid polysiloxane including a polysiloxane epoxy polymer; and
positioning the armor or fiber substrate coated with the hybrid polysiloxane coating in between the subject or group of subject and a potential ballistic, explosive, or puncture threat.
